(19) United States
(12) Patent Application Publication
(10) Pub. No.: US 2006/0200566 A1
(43) Pub. Date: Sep. 7, 2006

(54) Software proxy for securing web application business logic

(76) Inventor: Wayne William Ziebarth, Andover, MN (US)

Correspondence Address: SHERRILL LAW OFFICES, 4756 BANNING AVE, SUITE 212, WHITE BEAR LAKE, MN, 55110-3205, US

(21) Appl. No.: 11/074,344

(22) Filed: Mar. 7, 2005

(51) Int. Cl. G06F 15/16

(52) U.S. Cl. 709/227

(57) ABSTRACT

The invention describes a novel method for securing the Business Logic of on-line Internet applications against application manipulation attacks by means of identifying the exact manner in which the application was intended to be used (Intended Use Guidelines) and enforcing said intended use by embedding unique identification keys inside outgoing HTTP (HyperText Transfer Protocol) response headers and/or HTTP response HTML (HyperText Markup Language) streams and validating subsequent HTTP requests before submitting an independent HTTP request to a standard Web Server (HTTP daemon). Each unique identification key is mapped to one or more Intended Use Guidelines. The software is designed to be positioned behind an Internet-facing network firewall and in front of a standard Web Server. The software is further designed to accept TCP/IP (Transmission Control Protocol/Internet Protocol) socket connections from clients (typically standard Web browsers), validate incoming HTTP requests, and submit an independent HTTP request to the Web Server over a separate TCP/IP socket connection. The software is further designed to create an outgoing HTTP response with an appropriate status (error) code to the client before disconnecting the socket connection between the software and the Client in response to invalid HTTP requests. Under such conditions, an HTTP request is not created or sent to the Web Server, thereby avoiding any damage to the Web Server, the operating system on which the Web Server executes, and other internal network resources.

### BACKGROUND

Internet security has traditionally been focused at the network level in the form of firewalls and intrusion detection systems. Because network security has been so successful, attackers are now turning their attention to an easier target. Vulnerable web applications are proving to be fertile ground for attackers since there is no need to spend time and effort penetrating perimeter defenses—they simply get in through the same open TCP (Transmission Control Protocol) ports that legitimate users do.

Currently, it is estimated that over 80% of all Internet attacks take place through the standard TCP ports (80 and 443) used for HTTP (Hypertext Transport Protocol) traffic. HTTP is the underlying protocol used by every Web site and Web application on the Internet. Lost productivity alone jumped from $45 million in 1999 to $244 million in 2001 due to these types of attacks.

Typically, web application attacks cannot be prevented by network firewalls, intrusion-detection systems, or even encryption. These attacks work by exploiting the web server and the applications the web server runs, meaning the attackers enter through the same open “door” in the perimeter defenses that customers use to access the web server. Traditional perimeter defenses cannot distinguish malicious activity from normal, everyday web traffic.

Many of the most serious—and difficult to detect—Web application attacks take advantage of the stateless architecture of HTTP and the special programming required to develop useful applications for the Web. Specifically, two types of attacks exist in this area. Indiscriminate attacks are attacks in which the attacker has no interest in the particular organization associated with the web server or what the organization does. Indiscriminate attacks occur simply because of the fact that a Web server exists that can be exploited. For example, worms are forms of indiscriminate attacks. Worms travel from machine to machine without any regard to the particular function of the machine being attacked. The second type of attacks is a targeted (or discriminate) attack. In this case, the attacker has selected a web site for very specific reasons which might include financial gain, publicity, business disruption, etc. Various forms of parameter manipulation (such as cookie tampering) are examples of targeted attacks.

Conventionally, a common defense against indiscriminate attacks is extensive web server “hardening” and keeping third party software patches up-to-date. However, even the latest patches only provide protection against known attacks. In some instances, this defense can be reactive rather than proactive. Secure development practices are the best defense against some of the application manipulation attacks used in targeted attacks. However, not all targeted attacks can be successfully or practically mitigated through programming practices alone.

### SUMMARY

In general, in one aspect, the invention relates to a method for securing web application business logic comprising embedding unique keys into an outgoing HTTP response, sending an incoming HTTP request to access a web server, determining if the incoming HTTP request is valid using the unique keys, and responding to the incoming HTTP request if the incoming HTTP request is valid.

In general, in one aspect, the invention relates to a system for securing web application business logic comprising a client configured to send a request to access a web server, and a protection proxy configured to receive the request from the client, validate the request from the client using a unique key, receive a response to the request from the web server, update an Intended Use Guidelines database based on a response from the web server, and generate an outgoing response to the client including the unique key.

In general, in one aspect, the invention relates to a computer system for securing web application business logic comprising a processor, a memory, a storage device, and software instructions stored in the memory for enabling the computer system under control of the processor, to embed unique keys into an outgoing HTTP response, send an incoming HTTP request to access a web server, determine if the incoming HTTP request is valid using the unique keys, and respond to the incoming HTTP request if the incoming HTTP request is valid.

Other aspects and advantages of the invention will be apparent from the following description and the appended claims.

### BRIEF DESCRIPTION OF DRAWINGS

FIG. 1 shows an apparatus for securing web application business logic in accordance with one embodiment of the invention.

FIG. 2 shows a flow chart for a method of securing web application business logic in accordance with one embodiment of the invention.

FIG. 3 shows a computer system in accordance with one embodiment of the invention.

### DETAILED DESCRIPTION

Specific embodiments of the invention will now be described in detail with reference to the accompanying figures. Like elements in the various figures are denoted by like reference numerals for consistency. Further, the use of “ST” in the drawings is equivalent to the use of “Step” in the detailed description below.

In the following detailed description of embodiments of the invention, numerous specific details are set forth in order to provide a more thorough understanding of the invention. In other instances, well-known features have not been described in detail to avoid obscuring the invention

In general, embodiments of the invention relate to using a software proxy to secure web application business logic. Specifically, embodiments of the invention assign a unique key to critical elements of a web application's business logic. One or more embodiments of the invention compare the unique key against an Intended Use Guidelines database to ensure that the web application is being used in a correct capacity.

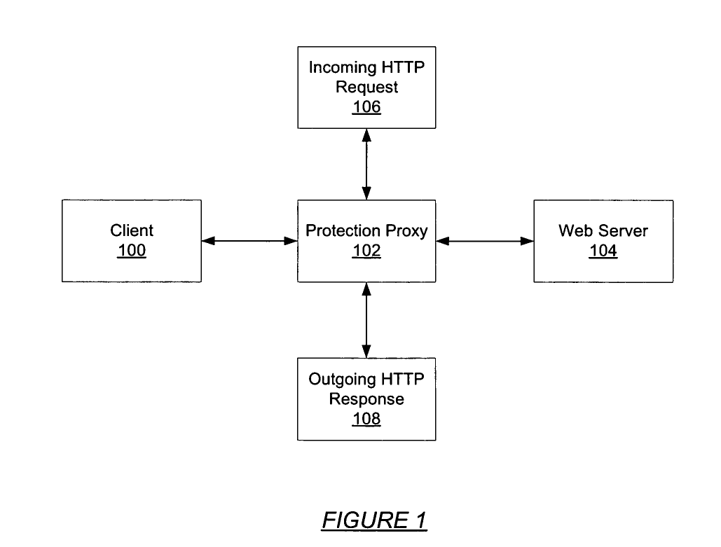

FIG. 1 shows an apparatus for securing web application business logic in accordance with one embodiment of the invention. Particularly, the apparatus of FIG. 1 includes a client (100), a protection proxy (102), a web server (104), and both and incoming HTTP request (106) and an outgoing HTTP request (108). In one embodiment of the invention, the client (100) requests access to a web server (104) that hosts one or more web applications (not shown). Typically, web applications have business logic (i.e., the back-end code base that allows the application to function) that includes critical elements such as HIDDEN HTML (HyperText Markup Language) form field values, TEXT HTML form field lengths, RADIO HTML form field values, SELECT OPTION form field values, CHECKBOX HTML form field values, URL (Universal Resource Locator) query string parameter values, and HTTP (HyperText Transport Protocol) cookie values, etc. Those skilled in the art will appreciate that although FIG. 1 shows only one client, there may be several clients requesting access to the web server.

In one embodiment of the invention, the protection proxy (102) is software that includes functionality to intercept incoming and outgoing requests to and from the client (100). More specifically, the protection proxy (102) generates an independent incoming HTTP request (106) on behalf of the client (100) and sends the incoming HTTP request (106) to the web server (104). Additionally, the protection proxy (102) generates an outgoing HTTP response (108) using the response from the web server (104) and sends the outgoing HTTP response (108) to the client (100). Further, in one embodiment of the invention, the protection proxy (102) is configured to validate the incoming requests against an Intended Use Guidelines database (not shown). In one embodiment of the invention, the Intended Use Guidelines database is a database of guidelines for using web sites or web applications associated with the web server (104).

In one embodiment of the invention, the protection proxy (102) uses unique keys (not shown) that are embedded into the outgoing HTTP response HTML streams in order to validate the incoming requests from the client (100). Specifically, the unique keys are used to index into the Intended Use Guidelines database (described in detail below). In one embodiment of the invention, the unique keys are added to the outgoing HTTP response by inserting a HIDDEN HTML form field into each HTML form present in the stream. Alternatively, in one embodiment of the invention, the unique keys may be embedded by appending the keys to existing URL query strings as an additional name or value parameter. The unique keys may also be embedded into the outgoing HTTP response headers as an HTTP cookie value when one or more application-assigned HTTP cookie values are present.

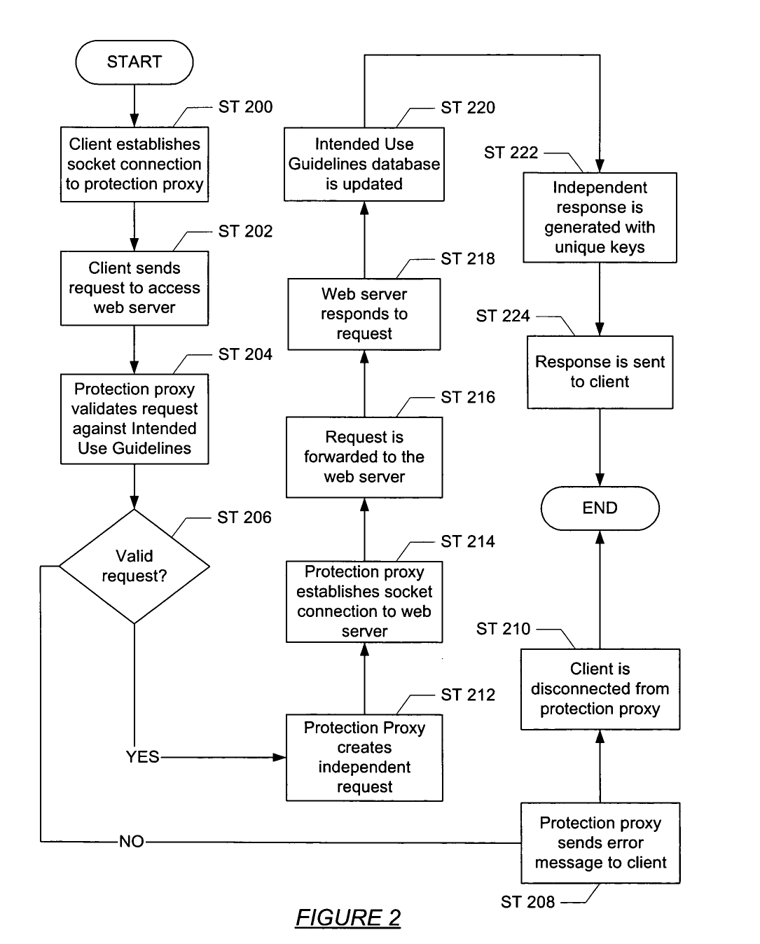

FIG. 2 shows a flow chart for securing web application business logic in accordance with one embodiment of the invention. Before the process shown in FIG. 2 begins, unique keys have been embedded into previous outgoing HTTP responses from the web server to the client. In this manner, the unique keys are received again at the protection proxy and the process of FIG. 2 is performed for each of the subsequent requests from the client. Therefore, elements appearing in subsequent incoming HTTP requests (i.e., either GET or POST method) are validated against the Intended Use Guidelines identified in the corresponding outgoing HTTP responses.

Initially, a client establishes a TCP/IP socket connection to the protection proxy (Step 200). Subsequently, the client sends a request to access a web server that may be hosting one or more web applications (Step 202). The protection proxy then validates the client request against the Intended Use Guidelines database (Step 204). In one embodiment of the invention, the Intended Use Guidelines database is stored in memory in the protection proxy. Alternatively, in one embodiment of the invention, the Intended Use Guidelines database may be stored on disk. Further, Intended Use Guidelines in the client request may be identified by parsing the HTML content of the request, parsing stylesheet content, parsing HTTP response headers, parsing SWF (i.e., FLASH file format) content executing in-line and external JavaScript and simulating user actions, etc.

At this stage, a determination is made as to whether the client request is a valid request (Step 206). In one embodiment of the invention, the protection proxy may validate the client request against the Intended Use Guidelines database using one or more fields within the specified within the request. For example, a particular Intended Use Guideline may compare the data within the hidden form fields associated with the request to ensure that these fields match those specified in the Intended Use Guidelines database. In this manner, the protection proxy is capable of ensuring that the hidden form fields in the request stay intact when the request is received at the corresponding web server. In other example, an Intended Use Guideline may specify that the prompt for the user ID should be twenty-five characters in length. In this case, the protection proxy may perform a length check to ensure that the user ID in the request is exactly twenty-five characters.

Those skilled in the art will appreciate that there may be several other types of compares and/or checks that may be performed to validate the client request. Additionally, those skilled in the will appreciate that the type of validation performed against the Intended Use Guidelines database may depend on the parameter/field that is used to validate the request.

Continuing with FIG. 2, if the client request is not valid (i.e., validation of the client request using a particular field against the Intended Use Guidelines is not successful), then the protection proxy sends an error message to the client over the TCP/IP socket connection (Step 208). Subsequently, the client is disconnected from the protection proxy (i.e., the TCP/IP socket connection is broken by the protection proxy) (Step 210) and the process ends. In contrast, if the client request is valid (Step 206), the protection proxy creates an independent HTTP request (Step 212). The independent HTTP request is subsequently sent over a second TCP/IP socket connection between the protection proxy and the web server (Step 214) to the web server (Step 216). The protection proxy then receives the response to the request from the web server (Step 218).

In one embodiment of the invention, the response from the web server is used to update the Intended Use Guidelines database (Step 220). Specifically, any new content in the response from the web server (that is capable of being verified) is used to add or modify Intended Use Guidelines that may be used to govern the validation of future client requests. In one embodiment of the invention, the updates to the Intended Use Guidelines database are made in real-time. Those skilled in the art will appreciate that the Intended Use Guidelines database may not be updated each time a response from the web server is received (i.e., if no new content exists in the response, then the database may not be updated). Continuing with FIG. 2, once the Intended Use Guidelines database is updated, another independent HTTP response is generated by the protection proxy (Step 222).

In one embodiment of the invention, the response is generated with the unique keys embedded into the response. This is because the unique keys need to be returned to the protection proxy the next time the client sends a request to the web server. If the unique keys used to index into the Intended Use Guidelines database are not included into the independent HTTP response, then the protection proxy will not receive the unique keys for future requests generated by the client. Subsequently, the independent HTTP request, with the response from the web server is forwarded to the client (Step 224) and the process ends.

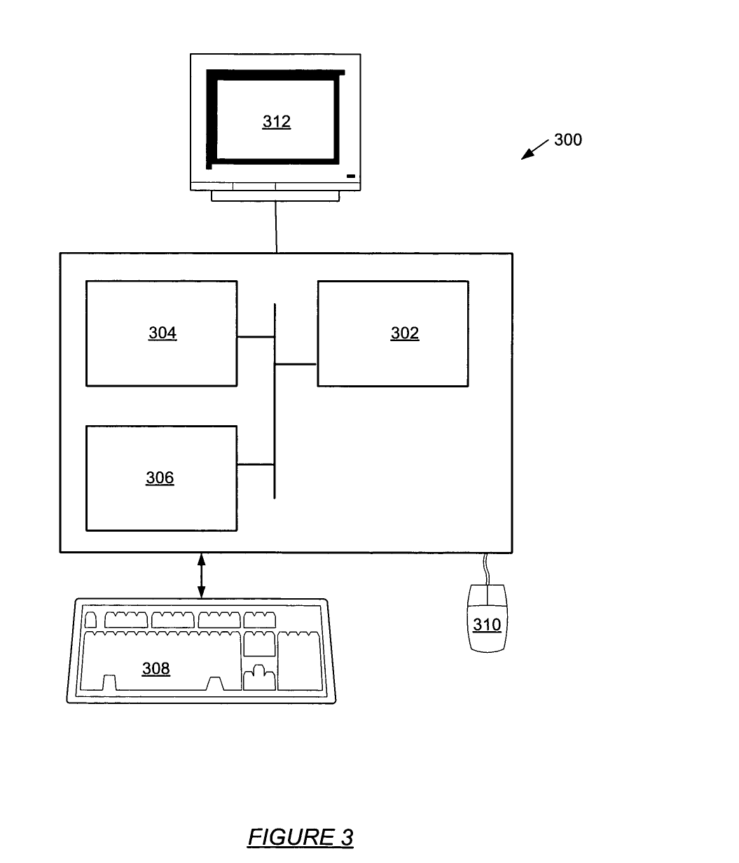

An embodiment of the invention may be implemented on virtually any type of computer regardless of the platform being used. For example, as shown in FIG. 3, a networked computer system (300) includes a processor (302), associated memory (304), a storage device (306), and numerous other elements and functionalities typical of today's computers (not shown). The networked computer (300) may also include input means, such as a keyboard (308) and a mouse (310), and output means, such as a monitor (312). The networked computer system (300) is connected to a local area network (LAN) or a wide area network via a network interface connection (not shown). Those skilled in the art will appreciate that these input and output means may take other forms. Further, those skilled in the art will appreciate that one or more elements of the aforementioned computer (300) may be located at a remote location and connected to the other elements over a network.

Embodiments of the invention provide a secure method of protecting web application business logic by using a software proxy to validate requests from clients. One or more embodiments of the invention allow the request from a client to be validated against an Intended Use Guidelines database that is stored in the software proxy. Specifically, embodiments of the invention provide a method to use unique keys to index into the Intended Use Guidelines database. Further, embodiments of the invention provide for the Intended Use Guidelines database to be updated based on any new parameters or information that may be included in the request from a client.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for securing web application business logic comprising:
embedding unique keys into an outgoing HTTP response;
sending an incoming HTTP request to access a web server;
determining if the incoming HTTP request is valid using the unique keys; and
responding to the incoming HTTP request if the incoming HTTP request is valid.

2. The method of claim 1, further comprising:
sending an error message, and
disconnecting the client if the incoming HTTP request is not valid.

3. The method of claim 1, wherein determining if the incoming HTTP request is valid comprises validating the incoming HTTP request against an Intended Use Guidelines database.

4. The method of claim 3, further comprising:
updating the Intended Use Guidelines database.

5. The method of claim 1, wherein the unique keys are used to index into an Intended Use Guidelines database.

6. The method of claim 4, wherein the Intended Use Guidelines database is stored in the protection proxy.

7. The method of claim 5, wherein the Intended Use Guidelines database is stored on disk.

8. The method of claim 1, wherein embedding the unique keys into an outgoing HTTP response comprises inserting the unique keys into one selected from the group consisting of outgoing HTML content as a URL query string parameter, outgoing HTTP response header as a cookie value, outgoing HTML content as a hidden HTML form field.

9. The method of claim 1, wherein the web server hosts a web application.

10. A system for securing web application business logic comprising:
a client configured to send a request to access a web server; and
a protection proxy configured to:
receive the request from the client;
validate the request from the client using a unique key;
receive a response to the request from the web server;
update an Intended Use Guidelines database based on a response from the web server; and
generate an outgoing response to the client including the unique key.

11. The system of claim 9, wherein the web server is configured to host a web application.

12. The system of claim 10, wherein the unique key is used to index into the Intended Use Guidelines database.

13. The system of claim 12, wherein the Intended Use Guidelines database is stored in the protection proxy.

14. The system of claim 12, wherein the Intended Use Guidelines database is stored on disk.

15. The system of claim 10, wherein the unique key is embedded into the outgoing HTTP response from the web server to the client.

16. The system of claim 15, wherein embedding the unique key comprises inserting the unique keys into one selected from the group consisting of outgoing HTML content as a URL query string parameter, outgoing HTTP response header as a cookie value, outgoing HTML content as a hidden HTML form field.

17. The system of claim 10, wherein validating the request from the client comprises parsing the request to identify an Intended Use Guideline and comparing the Intended Use Guideline against the Intended Use Guidelines database.

18. The system of claim 17, wherein identifying an Intended Use Guideline comprises one selected from the group consisting of parsing HTTP response headers, parsing stylesheet content, parsing HTML content, parsing SWF content, executing in-line and external JavaScript and simulating user actions.

19. The system of claim 10, wherein the protection proxy is further configured to generate an independent HTTP request to the web server and an independent HTTP response to the client.

20. A computer system for securing web application business logic comprising:
a processor;
a memory;
a storage device; and
software instructions stored in the memory for enabling the computer system under control of the processor, to:
embed unique keys into an outgoing HTTP response;
send an incoming HTTP request to access a web server;
determine if the incoming HTTP request is valid using the unique keys; and
respond to the incoming HTTP request if the incoming HTTP request is valid.
